(19) United States
(12) Patent Application Publication
(10) Pub. No.: US 2011/0127152 A1
(43) Pub. Date: Jun. 2, 2011

(54) BLIND POINT KEYSWITCH AND INPUT APPARATUS

(76) Inventor: Tsai-Jung Hu, Taoyuan (TW)

(21) Appl. No.: 12/947,778

(22) Filed: Nov. 16, 2010

(30) Foreign Application Priority Data
Dec. 1, 2009 (TW) 098222495

(51) Int. Cl. H01H 13/705; H01H 13/14

(52) U.S. Cl. 200/5 A; 200/341; 200/344

(57) ABSTRACT

The invention provides an input apparatus including a bottom plate and a plurality of keyswitches disposed on the bottom plate. Each keyswitch includes a blind point keyswitch. The blind point keyswitch includes a keycap and a blind point. The keycap has a smooth surface. The blind point is made of a specific material by a specific process, and the blind point is formed on the surface of the keycap for being a protrusion.

### BACKGROUND OF THE INVENTION

1. Field of the Invention

The present invention relates to a blind point keyswitch, and more particularly, to a blind point keyswitch whose shape and position is adjustable and a related input apparatus that.

2. Description of the Prior Art

With the advanced technology, a computer is now in widespread use in family, factory, office, school, and so on. The computer, such as a desktop computer and a notebook computer, is a necessary tool and includes a conventional keyboard for inputting information conveniently.

Generally, a mold is utilized for forming the blind point keyswitch during manufacturing process of the conventional keyboard. A hole is formed on the mold for injection molding of the blind point keyswitch, so that a shape of the blind point corresponds to a shape of the hole. Please refer to FIG. 1. FIG. 1 is a diagram of a conventional blind point keyswitch 1 in the prior art. The blind point keyswitch 1 includes a keycap 10, and a blind point 12 integrated with the keycap 10 monolithically by an injection molding method.

However, the conventional manufacturing method of the blind point keyswitch includes several drawbacks. A mold is developed for forming the blind point, resulting in complicated manufacturing process, which leads to increase of manufacturing cost and time. In addition, one mold only suits for one blind point with a corresponding shape and a corresponding position. The conventional blind point can not be designed according to user's demand, so that the blind point keyswitches with varies forms are made by corresponding molds. Thus, the conventional manufacturing method of the blind point keyswitch is expensive and lacks of flexibility in production.

### SUMMARY OF THE INVENTION

The present invention provides a blind point keyswitch and a related input apparatus. The present invention does not utilize a mold to form a blind point, and a shape and a position of the blind point on the blind point keyswitch are adjustable according to actual demand. Therefore, aesthetic feeling and flexibility in production of the input apparatus are increased.

According to the claimed invention, the input apparatus of the present invention includes a bottom plate and a plurality of keyswitches disposed on the bottom plate. Each keyswitch includes a blind point keyswitch, and the blind point keyswitch includes a keycap and a blind point. The keycap has a smooth surface. The blind point is made of a specific material by a specific process on the surface of the keycap for being a protrusion.

In the preferred embodiment, the specific process can be a printing process or a dispensing process. The specific material can be a print ink or an adhesive, and the print ink or the adhesive is solidified by ultraviolet ray. The keycap is made by an injection molding method via a mold, and a shape of the mold corresponds to a shape of the keycap, so that the keycap has the smooth surface.

In addition, the surface can be a surface treating layer, and the blind point is formed on the surface treating layer. The surface treating layer is made by a paint spraying method, an ink printing method, a heat transfer method, or an in-mold roller (IMR) method. A height of the protrusion is substantially between 0.05 mm and 0.3 mm, and the height of the protrusion can be increased by printing multi-layer ink.

According to the claimed invention, the blind point keyswitch is disposed on the input apparatus. The blind point keyswitch includes the keycap and the blind point. The keycap has the smooth surface. The blind point is made of the specific material by the specific process on the surface of the keycap for being a protrusion.

Generally, the blind point keyswitch can further include a bottom plate disposed under the keycap, and a supporting component disposed between the keycap and the bottom plate for moving the keycap relative to the bottom plate. The specific process can be the printing process or the dispensing process. The specific material can be the print ink or the adhesive, and the print ink or the adhesive is solidified by the ultraviolet ray. The keycap is made by the injection molding method via the mold, and the shape of the mold corresponds to the shape of the keycap, so that the keycap has the smooth surface.

In addition, the surface can be the surface treating layer, and the blind point is formed on the surface treating layer. The surface treating layer is made by the paint spraying method, the ink printing method, the heat transfer method, or the in-mold roller (IMR) method. The height of the protrusion is between substantially 0.05 mm and 0.3 mm, and the height of the protrusion can be increased by printing multi-layer ink.

The blind point keyswitch and the input apparatus of the present invention solves drawbacks of the conventional blind point keyswitch. The present invention does not need to utilize an additional mold to form the blind point keyswitch, so as to decrease manufacturing cost and labor hour for simplifying the manufacturing process of the blind point keyswitch.

In addition, a shape and a position of the blind point keyswitch of the present invention can be designed according to actual demand, which means the present invention does not develop mold to form the corresponding blind point keyswitch. Thus, the aesthetic feeling and flexibility in production of the blind point keyswitch of the present invention can be increased effectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional blind point keyswitch in the prior art.

FIG. 2 is a schematic diagram of an input apparatus according to a preferred embodiment of the present invention.

FIG. 3 is a structural diagram of a blind point keyswitch shown in FIG. 2 according to the preferred embodiment of the present invention.

FIG. 4A is a diagram of the blind point keyswitch according to a preferred embodiment of the present invention.

FIG. 4B is a diagram of a blind point keyswitch according to another embodiment of the present invention.

FIG. 4C is a diagram of a blind point keyswitch according to another embodiment of the present invention.

FIG. 4D is a diagram of the blind point keyswitch including a surface treating layer shown in FIG. 4A.

FIG. 5A is a diagram of a blind point keyswitch according to another embodiment of the present invention.

FIG. 5B is a diagram of a blind point keyswitch according to another embodiment of the present invention.

FIG. 5C is a diagram of a blind point keyswitch according to another embodiment of the present invention.

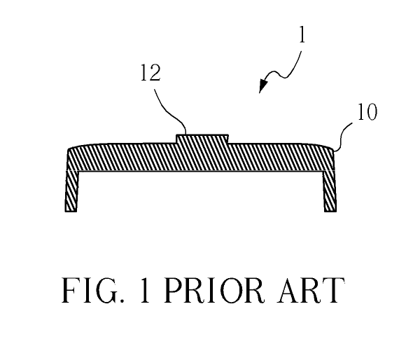

### DETAILED DESCRIPTION

According to an embodiment of the present invention, an input apparatus can be a keyboard or an electronic product with keyswitches, and it depends on actual demand.

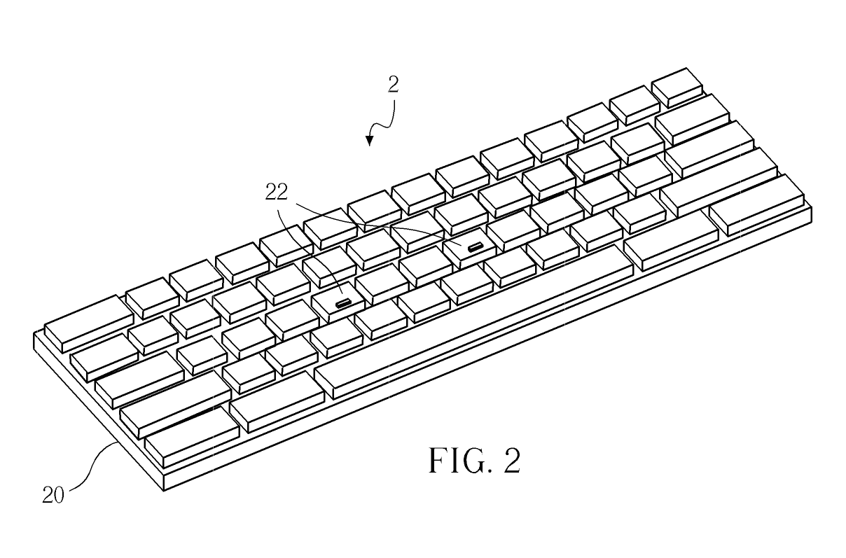

Please refer to FIG. 2. FIG. 2 is a schematic diagram of an input apparatus 2 according to a preferred embodiment of the present invention. As shown in FIG. 2, the input apparatus 2 can be a keyboard. The input apparatus 2 includes a bottom plate 20 and a plurality of keyswitches. The plurality of keyswitches includes a blind point keyswitch 22 with a protrusion.

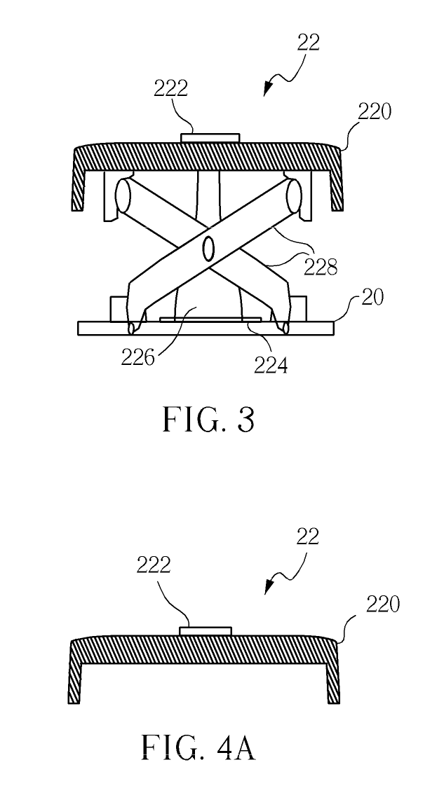

Please refer to FIG. 3. FIG. 3 is a structural diagram of the blind point keyswitch 22 shown in FIG. 2 according to the preferred embodiment of the present invention. As shown in FIG. 3, the blind point keyswitch 22 includes a keycap 220, a blind point 222, a flexible circuit board 224, a rubber cover 226, and a scissor-type member 228. It should be mentioned that the blind point keyswitch 22 is not limited to the structure shown in FIG. 3, and it depends on design demand.

In this embodiment, the keycap 220 moves downward to deform the rubber cover 226 when the blind point keyswitch 22 is pressed, so that a contacting portion disposed inside the rubber cover 226 contacts a switch disposed on the flexible circuit board 224, and then the switch can be actuated for transmitting a signal.

Generally, connection of the switch of the flexible circuit board 224 and the contacting portion of the rubber cover 226 can actuate an input or any other functions, such as entering a character. The scissor-type member 228 disposed between the keycap 220 and the bottom plate 20 is a supporting member for supporting the keycap 220 to move relative to the bottom plate 20. Thus, when pressure on the blind point keycap 22 is released, the scissor-type member 228 can move the blind point keycap 22 to an initial position where the blind point keycap 22 has not been pressed. Operation of the blind point keyswitch 22 of the input apparatus 2 is the same as operation of the conventional keyswitch, and the detailed description is omitted herein for simplicity.

In this embodiment, the keycap 220 of the blind point keyswitch 22 is made by an injection molding method via a mold, and a shape of the mold corresponds to a shape of the keycap 220, so that the keycap 220 has the smooth surface.

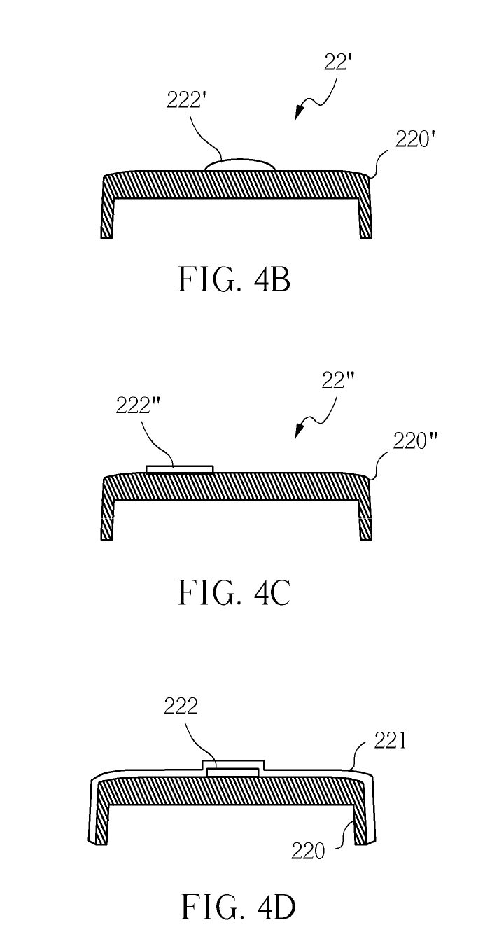

Please refer to FIG. 4A. FIG. 4A is a diagram of the blind point keyswitch 22 according to a preferred embodiment of the present invention. As shown in FIG. 4A, the keycap 220 of the blind point keyswitch 22 has the smooth surface, and the blind point 222 of the blind point keyswitch 22 made by a specific material can be formed on the surface of the keycap 220 by a specific process, so as to form a protrusion on the surface of the blind point keyswitch 22.

Generally, the specific process can be a printing process or a dispensing process. The specific material can be a print ink or an adhesive, and the print ink or the adhesive can be solidified for being the protrusion by ultraviolet ray. A height of the protrusion is substantially between 0.05 mm and 0.3 mm. Characteristic of the blind point 222 is not limited to the above-mentioned embodiment, and it depends on design demand.

For example, UV ink can be printed on the surface of the keycap 220 via the printing process, and then the UV ink can be solidified by the ultraviolet ray for being the blind point 222 of the blind point keyswitch 22. Or the UV ink can be formed on the surface of the keycap 220 via the dispensing process, and then the UV ink can be solidified by the ultraviolet ray for being the blind point 222 of the blind point keyswitch 22. Process of manufacturing the blind point 222 is not limited to above-mentioned embodiment, and it depends on actual demand.

It should be mentioned that a shape and a position of the blind point of the blind point keyswitch of the present invention can be adjusted by varying parameters of the specific process. For example, the shape of the blind point can be enlarged by increasing quantity of the specific material, and the position of the blind point can be changed by varying the specific process, so that aesthetic feeling of the keyswitch can be increased. In addition, the height of the blind point 222 can be increased by printing multi-layer ink.

Please refer to FIG. 4B. FIG. 4B is a diagram of a blind point keyswitch 22′ according to another embodiment of the present invention. As shown in FIG. 4B, a blind point 222′ disposed on a keycap 220′ of the blind point keyswitch 22′ is an arc protrusion, which is different from a rectangle blind point 222 shown in FIG. 4A. In addition, please refer to FIG. 4C, FIG. 4C is a diagram of a blind point keyswitch 22″ according to another embodiment of the present invention. As shown in FIG. 4C, a position of a blind point 222″ disposed on a keycap 220″ of the blind point keyswitch 22″ is different from the position of the blind point 222 disposed on the keycap 220. The shape and the position of the blind point is not limited to above-mentioned embodiments, and depend on design demand.

Furthermore, please refer to FIG. 4D, FIG. 4D is a diagram of the blind point keyswitch 22 including a surface treating layer 221 shown in FIG. 4A. As shown in FIG. 4D, the surface treating layer 221 can be formed on the blind point 222 and the keycap 220 after the blind point 222 made of the specific material is formed on the surface of the keycap 220 by the specific process. Generally, the surface treating layer 221 can be formed by a paint spraying method, an ink printing method, a heat transfer method, or an in-mold roller method.

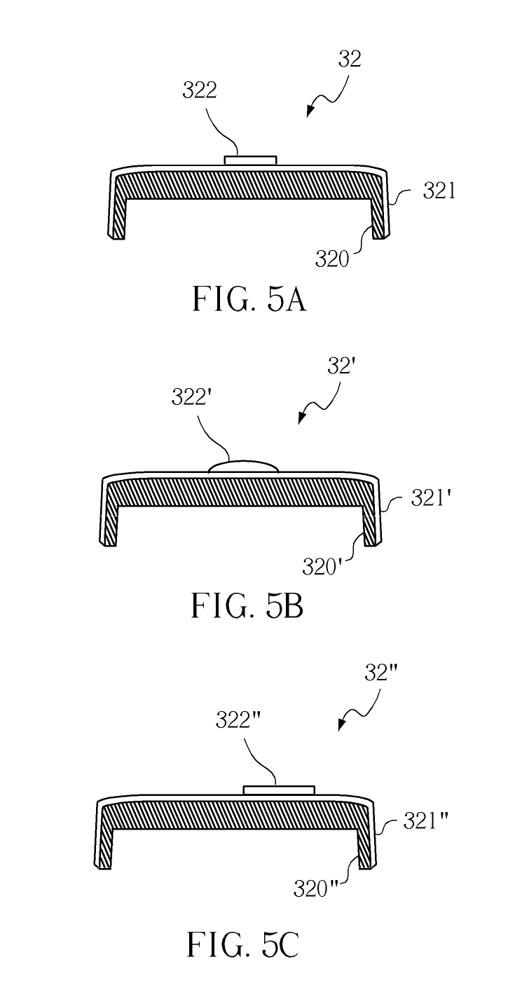

Please refer to FIG. 5A. FIG. 5A is a diagram of a blind point keyswitch 32 according to another embodiment of the present invention. As shown in FIG. 5A, a keycap 320 of the blind point keyswitch 32 has a smooth surface. In this embodiment, the surface can be a surface treating layer 321, and a blind point 322 made of a specific material can be formed on the surface treating layer 321 by a specific process for being a protrusion. Generally, the surface treating layer 321 can be formed on the keycap 320 of the blind point keyswitch 32 by a paint spraying method, an ink printing method, a heat transfer method, or an in-mold roller method.

Similarly, a shape and a position of the blind point of the blind point keyswitch according to the above-mentioned embodiment of the present invention can be adjusted by varying parameters of the specific process. For example, the shape of the blind point can be enlarged by increasing quantity of the specific material, and the position of the blind point can be changed by varying the specific process. In addition, a height of the blind point can be increased by printing multi-layer ink. Method of manufacturing the blind point is not limited to the above-mentioned embodiment, and it depends on design demand.

Please refer to FIG. 5B. FIG. 5B is a diagram of a blind point keyswitch 32′ according to another embodiment of the present invention. As shown in FIG. 5B, the blind point keyswitch 32′ disposed on the surface treating layer 321′ of the blind point keyswitch 32′ is an arc protrusion, which is different from the rectangle blind point 322 shown in FIG. 5A. The shape of the blind point is not limited to above-mentioned embodiment, and it depends on design demand.

In addition, please refer to FIG. 5C, FIG. 5C is a diagram of a blind point keyswitch 32″ according to another embodiment of the present invention. As shown in FIG. 5C, a position of the blind point 322″ on the surface treating layer 321″ is different from the position of the blind point 322 disposed on the surface treating layer 321 shown in FIG. 5A. The position of the blind point is not limited to above-mentioned embodiment, and it depends on actual demand.

According to the claimed invention, the blind point keyswitch is disposed on the input apparatus. The blind point keyswitch includes the keycap and the blind point. The keycap has the smooth surface. The blind point is made of the specific material by the specific process on the surface of the keycap for being a protrusion.

Generally, the blind point keyswitch can further include a bottom plate disposed under the keycap, and a supporting component disposed between the keycap and the bottom plate for moving the keycap relative to the bottom plate. The specific process can be the printing process or the dispensing process. The specific material can be the print ink or the adhesive, and the print ink or the adhesive can be solidified by the ultraviolet ray. The keycap can be made by the injection molding method via the mold, and the shape of the mold corresponds to the shape of the keycap, so that the keycap has the smooth surface.

In addition, the surface can be the surface treating layer, and the blind point is formed on the surface treating layer. The surface treating layer can be made by the paint spraying method, the ink printing method, the heat transfer method, or the in-mold roller (IMR) method. The height of the protrusion is substantially between 0.05 mm and 0.3 mm, and the height of the protrusion can be increased by printing multi-layer ink.

Comparing to the prior art, the blind point keyswitch and the input apparatus of the present invention solves drawbacks of the conventional blind point keyswitch. The present invention does not need to develop an additional mold to form the blind point keyswitch, so as to decrease manufacturing cost and labor hour for simplifying the manufacturing process of the blind point keyswitch. In addition, a shape and a position of the blind point keyswitch of the present invention can be designed according to actual demand, which means the present invention does not utilize mold to form the blind point keyswitch. Thus, the aesthetic feeling and flexibility in production of the blind point keyswitch of the present invention can be increased effectively.

Those skilled in the art will readily observe that numerous modifications and alterations of the device and method may be made while retaining the teachings of the invention.

What is claimed is:

1. A blind point keyswitch comprising:
a keycap having a smooth surface; and
a blind point formed on the surface of the keycap for being a protrusion, the blind point being made of a specific material by a specific process.

2. The blind point keyswitch of claim 1, further comprising:
a bottom plate disposed under the keycap; and
a supporting component disposed between the keycap and the bottom plate for moving the keycap relative to the bottom plate.

3. The blind point keyswitch of claim 1, wherein the specific process is a printing process or a dispensing process.

4. The blind point keyswitch of claim 1, wherein the specific material is a print ink or an adhesive.

5. The blind point keyswitch of claim 4, wherein the print ink or the adhesive is solidified by ultraviolet ray.

6. The blind point keyswitch of claim 1, wherein a height of the protrusion is substantially between 0.05 mm and 0.3 mm.

7. The blind point keyswitch of claim 1, wherein the smooth surface of the keycap is a surface treating layer, and the blind point is formed on the surface treating layer.

8. The blind point keyswitch of claim 7, wherein the surface treating layer is made by a paint spraying method, an ink printing method, a heat transfer method, or an in-mold roller (IMR) method.

9. The blind point keyswitch of claim 1, wherein the keycap is made by a mold in an injection molding manner.

10. The blind point keyswitch of claim 9, wherein a shape of the mold corresponds to a shape of the keycap for forming the smooth surface on the keycap.

11. An input apparatus comprising:
a bottom plate; and
a plurality of keyswitches disposed on the bottom plate, the plurality of keyswitches comprising a blind point keyswitch, the blind point keyswitch comprising:
a keycap having a smooth surface; and
a blind point formed on the surface of the keycap for being a protrusion, the blind point being made of a specific material by a specific process.

12. The input apparatus of claim 11, wherein the specific process is a printing process or a dispensing process.

13. The input apparatus of claim 11, wherein the specific material is a print ink or an adhesive.

14. The input apparatus of claim 13, wherein the print ink or the adhesive is solidified by ultraviolet ray.

15. The input apparatus of claim 11, wherein a height of the protrusion is between substantially 0.05 mm and 0.3 mm.

16. The input apparatus of claim 11, wherein the smooth surface of the keycap is a surface treating layer, and the blind point is formed on the surface treating layer.

17. The input apparatus of claim 16, wherein the surface treating layer is made by a paint spraying method, an ink printing method, a heat transfer method, or an in-mold roller (IMR) method.

18. The input apparatus of claim 11, wherein the keycap is made by a mold in an injection molding manner.

19. The input apparatus of claim 18, wherein a shape of the mold corresponds to a shape of the keycap for forming the smooth surface on the keycap.
